(19) United States
(12) Patent Application Publication
(10) Pub. No.: US 2020/0188074 A1
(43) Pub. Date: Jun. 18, 2020

(54) Method for Using Sheet for Preventing Inflammation Caused by Excess Dental Cement and Inflammation Prevention Sheet

(71) Applicant: Sankyo Seimitsu Corporation, Yamanashi (JP)

(72) Inventors: Sugimoto Ryuma, Minami-Alps City, Yamanashi (JP); Kamijyo Daisuke, Minami-Alps City, Yamanashi (JP)

(73) Assignee: Sankyo Seimitsu Corporation, Yamanashi (JP)

(21) Appl. No.: 16/621,481

(22) PCT Filed: Jul. 24, 2017
(86) PCT No.: PCT/JP2017/026592

§ 371 Date: Dec. 11, 2019

(51) Int. Cl. A61C 19/06; A61C 5/85; A61C 5/82

(52) U.S. Cl. CPC A61C 19/063; A61C 5/82; A61C 5/85

(57) ABSTRACT

[Object] Provided is means for being capable of simply and reliably preventing an excess dental cement from infiltrating into a gingival crevice when cement retention is applied in a dental treatment.

[Solving Means] There is provided a method for using an inflammation prevention sheet that prevents inflammation caused by an excess of a dental cement used in a dental treatment, the method including inserting a treatment tooth through a hole provided in an elastic sheet made of rubber and/or plastic, and setting the sheet so as to cover an entirety of a periodontal region of the treatment tooth, subsequently, covering the treatment tooth with a crown, and bonding together both with the dental cement, and thereafter, removing the inflammation prevention sheet to which an excess dental cement, which has escaped from a root of the crown, has adhered.

### TECHNICAL FIELD

The present invention relates to a method for using an inflammation prevention sheet for preventing inflammation of the periodontal region caused by an excess of a dental cement used in a dental treatment, and an inflammation prevention sheet used in the method for using thereof.

### BACKGROUND ART

In the dental tooth decay treatment, a treatment such as cutting away a decayed tooth part and filling a cut portion with a filling (“inlay”), or covering a cut tooth serving as a base (abutment tooth) with a covering crown (“tooth crown” or “crown”) is widely performed. In addition, as one of dental treatment, in recent years, the implant treatment has been widely spread, and a treatment, such as implanting an artificial tooth root in the jawbone from which a tooth is pulled out and fixing an artificial tooth above to the artificial tooth root, is also widely performed. The implant treatment has such difficulties that surgery is required and the treatment cost is high, but since the implant treatment provides a better appearance than the denture base and provides good masticatory performance, the patients' needs for the implant treatment is growing.

FIG. 9 shows views for describing a tooth decay treatment which is typically performed, FIG. 9(a) is a view illustrating a treatment with a filling in which only a decayed tooth part is cut away, as much white part as possible is left, and a cut portion 21 is filled with an inlay 8a. FIG. 9(b) is a view illustrating a treatment in which a tooth is overall cut away and the tooth serving as an abutment tooth is covered with a crown. In such tooth decay treatment, a dental cement is used to join together the inlay and the tooth, or to join together the crown and the tooth, and the cut portion or the inside of the crown is filled with the dental cement.

FIG. 10 is a schematic cross-sectional view of a tooth implanted in the implant treatment. Unlike the tooth decay treatment, in the dental implant treatment, firstly, an artificial tooth root 2 called a fixture made of metal (particularly, titanium) is implanted in an alveolar bone 1 of the chin by being screwed thereinto, subsequently, an abutment 3 which is a support connection member is screwed with the fixture, the abutment 3 is covered above with an upper structure (“tooth crown” or “crown”) of a tooth, and the abutment 3 and a tooth crown 8 are joined together.

As a method for joining together the abutment 3 and the tooth crown 8, a screwing method (screw retention) and a bonding method (cement retention) with a dental cement layer 11 illustrated in FIG. 10 are mainly used. Since the cement retention provides a good appearance for the treated tooth, facilitates simple occlusal adjustment, and is low cost, the cement retention out of the methods becomes a mainstream in joining the tooth crown.

On the one hand, in the tooth decay treatment or the cement retention of the implant treatment, the harmfulness of an excess dental cement which has escaped from a root of the abutment tooth or the tooth crown has been viewed as a problem. The problem is that an excess dental cement enters the gingival crevice (periodontal pocket) and causes inflammation to the periodontal region due to being difficult to remove the excess dental cement. A progress of the inflammation may cause a progress of periodontal disease.

In addition, in the implant treatment, the excess dental cement may cause a trouble such as an implant being detached. Particularly, in the implant treatment, a fixture made of titanium has a poor adhesion to the internal tissue of the gingival crevice and the gingival crevice tends to become deep compared to the natural teeth. For this reason, the excess dental cement may enter a deep portion of the gingival crevice, and in this case, it is very difficult to remove the excess dental cement.

It has been considered that a residue of the dental cement becomes a hotbed of inflammation causative bacteria and causes inflammation of the periodontal region or the detachment of an implant. The current status is that there has been no fundamental solution to prevent the problem caused by the excess dental cement.

Non-Patent Document 1: Suzuki Takanori; Scientific Journal of Japan Institute for Advanced Dentistry, Vol. 20, No. 4, 235-240, 2014

### DISCLOSURE OF THE INVENTION

### Problem to be Solved by the Invention

As described above, a residue of the dental cement becomes a hotbed of inflammation causative bacteria, and causes inflammation of the periodontal region or the detachment of an implant. An excess dental cement which has escaped from a seam (margin portion) between the crown and the abutment tooth or a seam (margin portion) between the tooth crown and the abutment can be relatively easily removed with a dental explorer or dental scaler, but it becomes very difficult to remove the dental cement which has deeply entered the gingival crevice. If the excess dental cement is scraped out too hard by an explorer made of stainless steel, the surface of the abutment tooth or abutment may be scratched and scratches may promote the reproduction of periodontopathic bacteria, which is a problem. In addition, it is also difficult to remove the excess dental cement in the deep portion of the gingival crevice.

Whether or not the excess dental cement enters the gingival crevice is dependent also on the position of the margin portion. If the margin portion is positioned slightly higher than the gingival margin, there are rare cases where the excess dental cement enters the deep portion of the gingival crevice. However, if the margin portion is positioned at the same level or lower than the gingival margin, the excess dental cement easily enters the deep portion of the gingival crevice.

From the viewpoint of reducing harmful effects of the excess dental cement, desirably, the margin portion is positioned higher than the gingival margin, but since the margin portion can be easily seen, preferably, the margin portion is not positioned high from the viewpoint of aesthetics. Therefore, if there is a method for capable of preventing the excess dental cement from entering the gingival crevice even though the margin portion is positioned lower than the gingival margin, the method solves the problems all at once. However, such means has not yet been found at all.

An object of the invention is to provide new means for preventing an excess dental cement escaping from a filling, crown, or margin portion from infiltrating into the gingival crevice when cement retention is applied in the tooth decay treatment or the dental implant treatment, and to fundamentally solve a problem such as inflammation of the periodontal region caused by the excess dental cement.

### Means for Solving Problem

A method for using a sheet for preventing inflammation caused by an excess dental cement in the invention to solve the problems is a method for using an inflammation prevention sheet that prevents inflammation caused by an excess of a dental cement for dental used in a dental treatment, the method including:

inserting a treatment tooth through a hole provided in an elastic sheet made of rubber and/or plastic, and setting the sheet so as to cover an entirety of a periodontal region of the treatment tooth; subsequently, filling the treatment tooth with a filling or covering the treatment tooth with a covering crown, and bonding together both with the dental cement; and

thereafter, removing the inflammation prevention sheet to which an excess dental cement, which has escaped from a root of the crown, has adhered.

In addition, a method for using a sheet for preventing inflammation caused by an excess dental cement in the invention is a method for using an inflammation prevention sheet that prevents inflammation caused by an excess of a dental cement used in a dental implant treatment in which a fixture is implanted in a jawbone and is joined to an abutment, the abutment is covered with a tooth crown, and both are bonded together with the dental cement, the method including:

inserting the abutment through a hole provided in an elastic sheet made of rubber and/or plastic, and setting the sheet so as to cover a circumferential portion of a gingival crevice; and

removing the inflammation prevention sheet to which an excess dental cement, which has escaped from a seam between the tooth crown and the abutment after the abutment is covered with the tooth crown and both are bonded together with the dental cement, has adhered.

In the method for using an inflammation prevention sheet, desirably, the inflammation prevention sheet to which the excess dental cement has adhered is removed before the cement is hardened. In addition, preferably, the hole is a cut provided at a center of the inflammation prevention sheet.

According to the invention, there is provided an inflammation prevention sheet that prevents inflammation caused by an excess of a dental cement used in a treatment in which a treatment tooth with a decayed tooth part cut away is covered with a filling or a covering crown and the treatment tooth and the filling or the covering crown are bonded together with the dental cement,

in which the inflammation prevention sheet is an elastic sheet made of rubber or plastic, which has a hole in a central portion, in which the treatment tooth is inserted through the hole, and which is set so as to cover an entirety of a periodontal region of the treatment tooth.

In addition, according to the invention, there is provided an inflammation prevention sheet that prevents inflammation caused by an excess of a dental cement used in a dental implant treatment in which a fixture is implanted in a jawbone and is joined to an abutment, the abutment is covered with a tooth crown, and both are bonded together with the dental cement,

in which the inflammation prevention sheet is an elastic sheet made of rubber and/or plastic, which has a hole having a diameter slightly smaller than a diameter of the abutment, in which the abutment is inserted through the hole, and which is set so as to cover an entirety of a periodontal region of a tooth which is a target for the treatment.

Preferably, a thickness of the inflammation prevention sheet is 0.05 to 1.0 mm.

In addition, preferably, the inflammation prevention sheet is made of a silicone resin or a fluorine resin which is water repellent. In addition, preferably, the hole is a circular hole, a star-shaped hole, or an x-shaped hole, and desirably, the sheet is colored red, blue, green, or the like in advance. The reason for coloring is that it becomes easy to see the sheet by the eyes.

### Effect of the Invention

According to the invention, in the dental treatment and the dental implant treatment, it is possible to reliably prevent the excess dental cement, which has escaped from a margin portion when cement retention is applied, from infiltrating into the gingival crevice by using simple means. Therefore, it is possible to fundamentally solve a problem such as inflammation of the periodontal region caused by the excess dental cement in the dental treatment and the dental implant treatment.

### BEST MODE(S) FOR CARRYING OUT THE INVENTION

Hereinbelow, a preferable embodiment of the invention will be described. FIG. 1 shows views for describing an operation sequence of a method for using an inflammation prevention sheet of the invention in a treatment in which an abutment tooth 3c with a decayed tooth part cut away is covered above with a crown 8b. As illustrated in FIG. 1(a), the abutment tooth 3c is inserted through a hole 5 provided at the center of an inflammation prevention sheet 4, and the inflammation prevention sheet 4 is set so as to cover an upper portion of a gingiva 6, particularly the entire circumference of a gingival crevice 7.

The diameter of the hole 5 is slightly smaller than the diameter of the abutment tooth 3. As illustrated in FIG. 1(b), since a bent portion 5a is formed around the edge of the hole 5 due to the inflammation prevention sheet 4 being elastic, and the portion tightens around the abutment tooth 3, and the inflammation prevention sheet 4 is in close contact with the abutment tooth 3.

Subsequently, as illustrated in FIG. 1(c), the abutment tooth 3c is covered with the crown 8b, and is bonded to the crown 8b with a dental cement. Namely, the inner circumference of the crown 8b and/or the outer circumference of the abutment tooth 3c are coated with the dental cement in advance, and the abutment tooth 3c is covered with the crown 8b. At that time, an excess dental cement escapes from a seam (margin portion) between the crown 8b and the abutment tooth 3c.

Since the margin portion is positioned higher than the bent portion 5a of the circular hole, the escaped excess dental cement flows on the surface of the inflammation prevention sheet 4, and an excess dental cement layer 9 is formed. In addition, since the inflammation prevention sheet 4 is in close contact with the abutment tooth 3c, it is possible to prevent the excess dental cement from infiltrating into the gingival crevice 7.

Subsequently, if an end portion of the inflammation prevention sheet 4 is pinched and pulled up (with a forceps or the like), the hole 5 becomes enlarged, and the inflammation prevention sheet 4 is come off from the crown 8b. In addition, since the inflammation prevention sheet 4 is made of a water repellent material which makes it difficult for the excess dental cement layer 9 to adhere thereto (easily peels off therefrom), it is possible to easily remove the excess dental cement layer 9 due to the excess dental cement layer 9 peeling off and breaking along with the deformation of the inflammation prevention sheet 4. Therefore, it is possible to reliably prevent the excess dental cement from entering the gingival crevice 7.

FIG. 2 shows views for describing an operation sequence of a method for using the inflammation prevention sheet in an implant treatment of the invention. As illustrated in FIG. 2(a), a fixture 2 is implanted in an alveolar bone 1, and an abutment 3 is screwed with the fixture 2. Thereafter, as illustrated in FIG. 2(b), the abutment 3 is inserted through the hole 5 provided at the center of the inflammation prevention sheet 4, and the inflammation prevention sheet 4 is set so as to cover the upper portion of the gingiva 6, particularly the entire circumference of the gingival crevice 7.

At that time, the diameter of the hole 5 is slightly smaller than the diameter of an abutment base portion 3a. In addition, since the bent portion 5a is formed around the edge of the hole 5 due to the inflammation prevention sheet 4 being elastic, and the portion tightens around the abutment base portion 3a, and the inflammation prevention sheet 4 is in close contact with the abutment base portion 3a.

Subsequently, as illustrated in FIG. 2(c), the abutment 3 is covered with a tooth crown 8, and is bonded to the tooth crown 8 with a dental cement. Namely, the inner circumference of the tooth crown 8 and/or the outer circumference of the abutment 3 are coated with the dental cement in advance, and the abutment 3 is covered with the tooth crown 8. At that time, an excess dental cement escapes from a seam (margin portion) between the tooth crown 8 and the abutment 3.

Since the margin portion is positioned higher than the bent portion 5a of the hole, the escaped excess dental cement flows on the surface of the inflammation prevention sheet 4, and the excess dental cement layer 9 is formed. In addition, since the inflammation prevention sheet 4 is in close contact with the abutment 3, it is possible to prevent the excess dental cement from infiltrating into the gingival crevice 7.

Subsequently, as illustrated in FIG. 2(d), if the end portion of the inflammation prevention sheet 4 is pinched and pulled up (with a forceps or the like), the hole 5 becomes enlarged, and the inflammation prevention sheet 4 passes through a large diameter portion of the crown 8. In addition, since the inflammation prevention sheet 4 is made of a water repellent material which makes it difficult for the excess dental cement layer 9 to adhere thereto (easily peels off therefrom), it is possible to easily remove the excess dental cement layer 9 due to the excess dental cement layer 9 peeling off and breaking along with the deformation of the inflammation prevention sheet 4. Therefore, it is possible to reliably prevent the excess dental cement from entering the gingival crevice 7.

A first key point of the method for using the inflammation prevention sheet of the invention is that since a hole is provided in the vicinity of the center of the inflammation prevention sheet 4, a treatment tooth, abutment tooth, or abutment is inserted through the hole, and the periodontal region is covered with the inflammation prevention sheet 4, the entire circumference of the gingival crevice can be simply and reliably covered therewith.

In addition, a second key point is that since the inflammation prevention sheet 4 is made of an elastic material and the diameter of the hole 5 thereof is smaller than the diameter of the abutment base portion 3a, an edge 5a of the hole 5 tightens around the abutment base portion 3a, and thus it is possible to reliably prevent the excess dental cement from leaking from a gap between both.

FIG. 3 shows views illustrating the shape of the inflammation prevention sheet of the invention, FIG. 3(a) is a plan view, and FIG. 3(b) is a side view. The inflammation prevention sheet 4 had a square shape, a length L of a side was 10 mm, and a diameter d of the circular hole was 3.5 mm. In addition, the sheet having a thickness (t) of 0.2 mm was used.

The inflammation prevention sheet of the invention is not necessarily limited to having a square shape, but may have a rectangular shape, or may have various shapes such as circular shape and elliptical shape. The dimensions of the inflammation prevention sheet are not necessarily limited to the foregoing dimensions. The point is that a proper size may be selected while taking into consideration the extent of the gingival region to be covered. Also the hole is not limited to having a circular shape, but may have various shapes such as star shape, diamond shape, and x shape. Also the diameter d of the circular hole is not necessarily to the foregoing dimension, but a circular hole having a proper diameter may be selected while taking into consideration the diameter of a treatment tooth, abutment tooth, or abutment base portion. Alternatively, it is also conceivable to prepare a large number of inflammation prevention sheets having different diameters d, and to select and use an inflammation prevention sheet having a proper diameter at a treatment site.

Also the thickness t of the sheet is not necessarily limited to the foregoing dimension, but is desirably in a range of 0.05 to 1.0 mm. The reason is that if t is less than 0.05 mm, a problem such as the sheet breaking during being set may arise, and if t exceeds 1.0 mm, it becomes difficult to handle the sheet due to a lack of flexibility.

Preferably, a water repellent material, for example, a silicone resin or a fluorine resin may be used as the material of the inflammation prevention sheet. The reason is that an excess dental cement adhering to the sheet peels off easily. In the example, an elastic sheet made of a silicone resin was used. In addition, the tensile strength (tensile break stress) of the sheet was 5.1 N, and the elongation at break was 59.3%.

FIG. 4 shows views illustrating other shapes of the inflammation prevention sheet. FIGS. 4(a) and 4(b) are views illustrating the shape of an inflammation prevention sheet having an x-shaped hole through which a treatment tooth, abutment tooth, abutment, or the like passes. FIGS. 4(c) and 4(d) are views illustrating the shape of an inflammation prevention sheet having a star-shaped hole. Compared to a circular hole, the x-shaped hole through which the treatment tooth or the like passes is more difficult for the treatment tooth or the like to pass through. However, it is possible to increase an area covering around the gingiva, and to more reliably prevent an excess dental cement from entering the gingival crevice by employing the x-shaped hole. In addition, the inflammation prevention sheet having a star-shaped hole has such merits that it is easy for the treatment tooth or the like to pass therethrough and also an upper portion of part of the treatment tooth can be covered therewith.

FIG. 5 shows views for describing a method for using the inflammation prevention sheet 4 in the implant treatment when there is an adjacent tooth in close proximity. In this case, as illustrated in FIG. 5(a), when the abutment 3 is inserted through the hole 5 of the inflammation prevention sheet 4 and the inflammation prevention sheet 4 is set, an adjacent tooth 10 becomes a disturbance. However, if an edge of the inflammation prevention sheet 4 is bent upward along a side surface of the adjacent tooth 10, the adjacent tooth 10 becomes no trouble at all.

In this state, as illustrated in FIG. 5(b), if the abutment 3 is covered with the crown 8, a gap hardly occurs on a side where the adjacent tooth 10 is located. For this reason, an excess dental cement does not escape in a direction to the side, and a majority of the excess dental cement escapes in other directions (in a forward and rearward direction and to an opposite side). Therefore, no trouble with removing the inflammation prevention sheet 4 occurs particularly.

When a gap between the teeth, namely, the crown 8 and the adjacent tooth 10 is small and the inflammation prevention sheet 4 cannot be pulled out upward, if part of the inflammation prevention sheet 4 is cut and the sheet interposed in the gap is pulled out forward, it is possible to remove the inflammation prevention sheet 4 without any problem. Note that FIG. 3 illustrates a case where an adjacent tooth is present only on one side, but it is apparent that there is no trouble even though adjacent teeth are present both sides. Note that this is not limited to the implant treatment, and similarly, can be applied also to the tooth decay treatment using an inlay or crown.

Since the inflammation prevention sheet of the invention is very small and light, there is such problem that the inflammation prevention sheets are easily scattered and lost during handling. For this reason, from the viewpoint of manufacturing, transporting, and storing the sheets, desirably, a collective sheet is used. FIG. 6 shows views illustrating an example of the shape of a collective sheet including inflammation prevention sheets, each of which has a circular hole provided in a central portion, in an example of the invention, FIG. 6(a) illustrates a sheet having one row, and FIG. 6(b) illustrates a sheet having a plurality of rows.

If the collective sheet is cut along a broken line portion, it is possible to obtain an isolated sheet. Since the sheet is made of thin rubber or plastic, it is possible to easily cut the sheet with a scissors or knife at a treatment site. Moreover, since generally, a thin sheet made of a silicone resin or a fluorine resin is transparent or translucent, when the sheet is set on the gum, it is difficult to identify the position thereof. For this reason, desirably, the sheet needs to be colored red, blue, green, or the like in advance.

FIG. 7 shows views illustrating an example of a collective sheet including inflammation prevention sheets, each of which has a star-shaped hole provided in a central portion, which is another example of the inflammation prevention sheet of the invention, FIG. 7(a) illustrates a sheet having one row, and FIG. 7(b) illustrates a sheet having a plurality of rows. FIG. 8 shows views illustrating an example of a collective sheet including inflammation prevention sheets, each of which has an x-shaped hole provided in a central portion, which is another example of the invention, FIG. 8(a) illustrates a sheet having one row, and FIG. 8(b) illustrates a sheet having a plurality of rows. The collective sheets are made of the same material and include the same features as those of the inflammation prevention sheet having a circular hole in a central portion which has been described above.

### BRIEF DESCRIPTION OF DRAWINGS

FIG. 1 shows views for describing an operation sequence of a method for using an inflammation prevention sheet of the invention in a treatment in which the entirety of an abutment tooth 3c with a decayed tooth part cut away is covered above with a crown 8b;

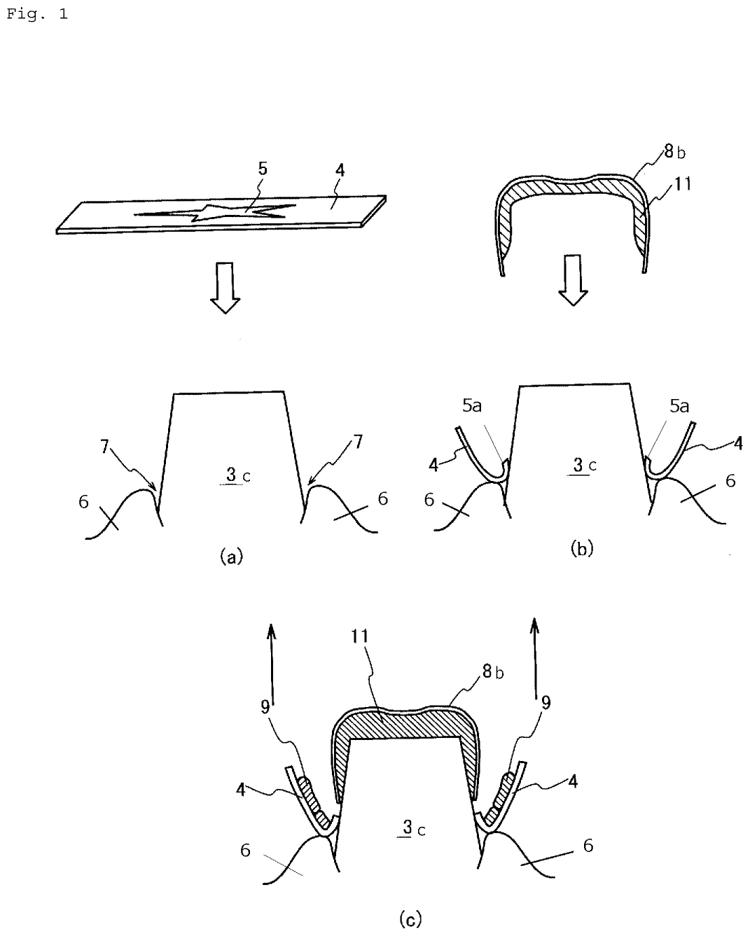

FIG. 2 shows views for describing an operation sequence of a method for using the inflammation prevention sheet in an implant treatment of the invention;

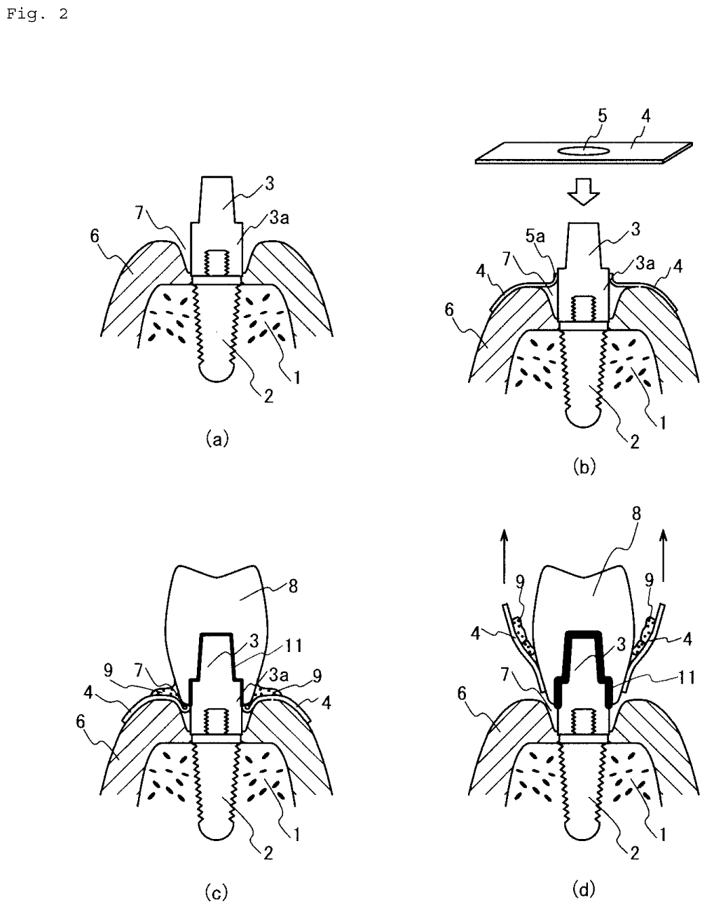

FIG. 3 shows views illustrating a shape of the inflammation prevention sheet in one example of the invention;

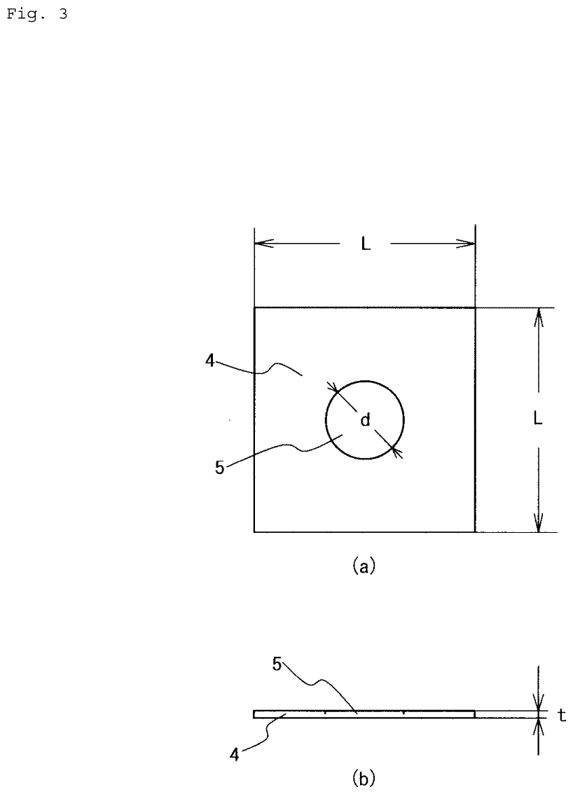

FIG. 4 shows views illustrating other shapes of the inflammation prevention sheet;

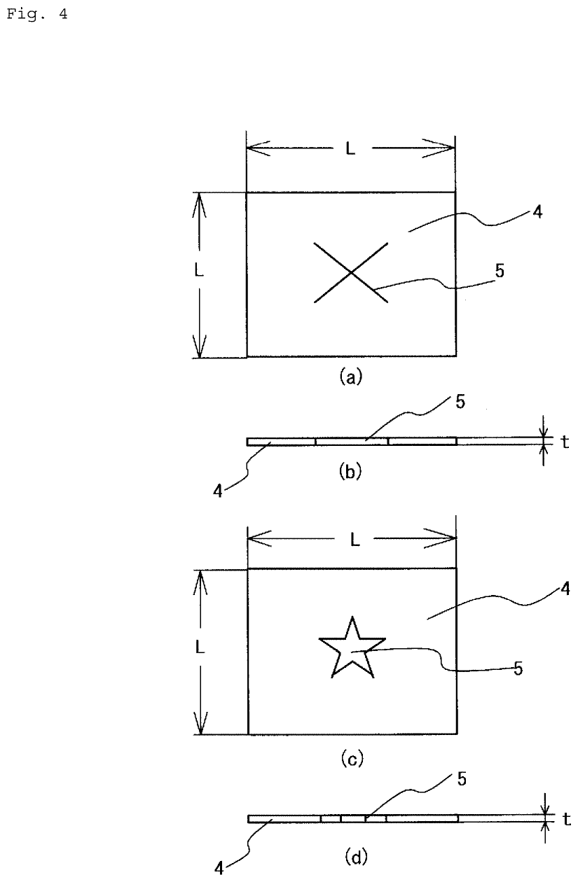

FIG. 5 shows views for describing a method for using the inflammation prevention sheet 4 in the implant treatment when there is an adjacent tooth in close proximity;

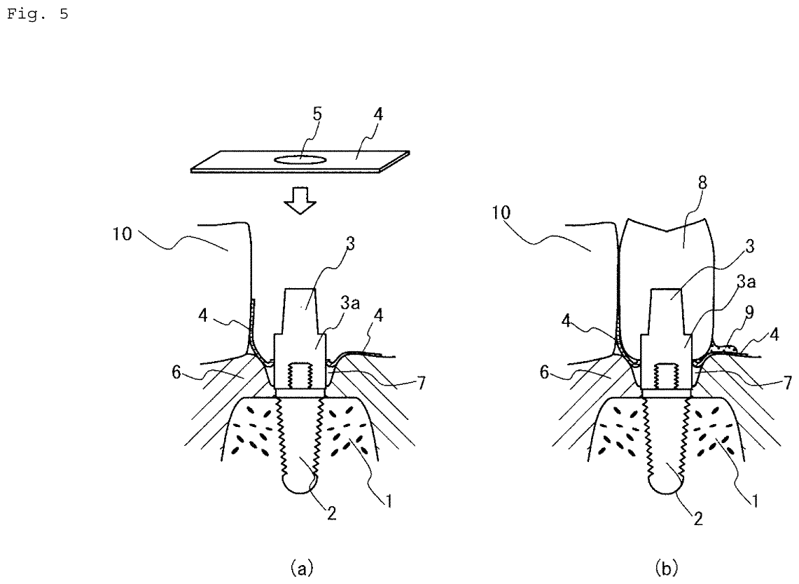

FIG. 6 shows views illustrating an example of the shape of a collective sheet including inflammation prevention sheets, each of which has a circular hole provided in a central portion, in an example of the invention;

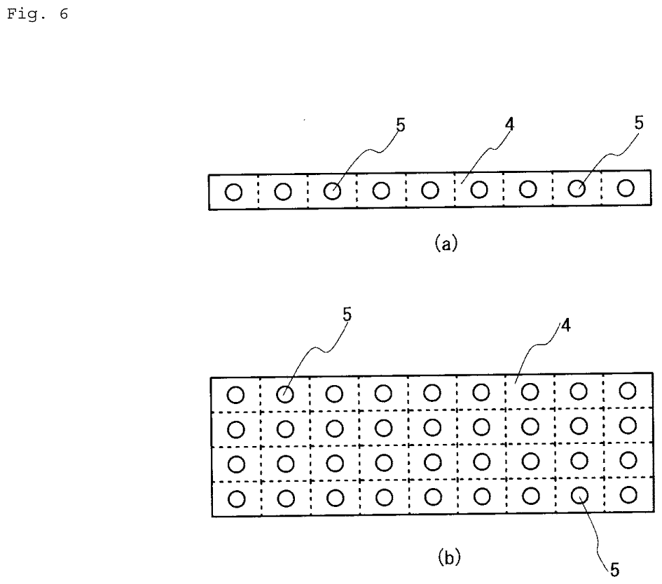

FIG. 7 shows views illustrating an example of the shape of a collective sheet including inflammation prevention sheets, each of which has a star-shaped hole provided in a central portion, in an example of the invention;

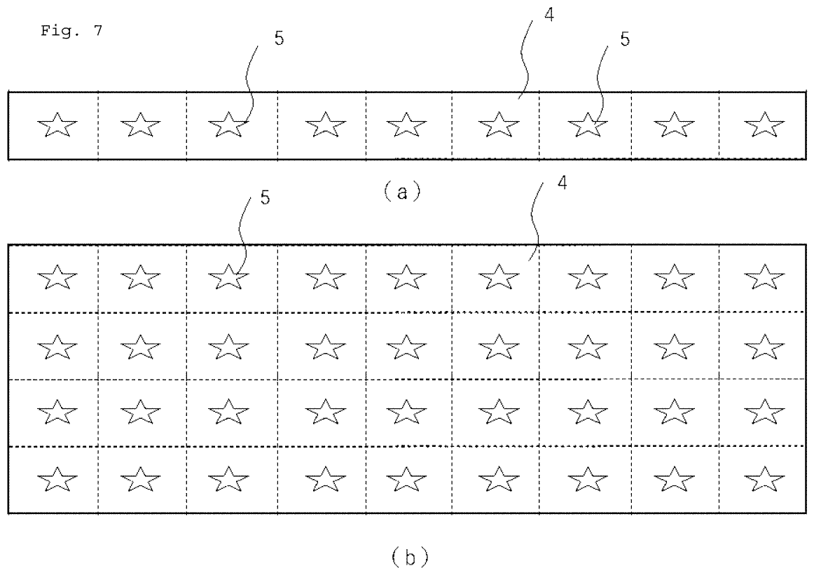

FIG. 8 shows views illustrating an example of the shape of a collective sheet including inflammation prevention sheets, each of which has an x-shaped hole obtained by making an x-shaped cut in a central portion, in an example of the invention;

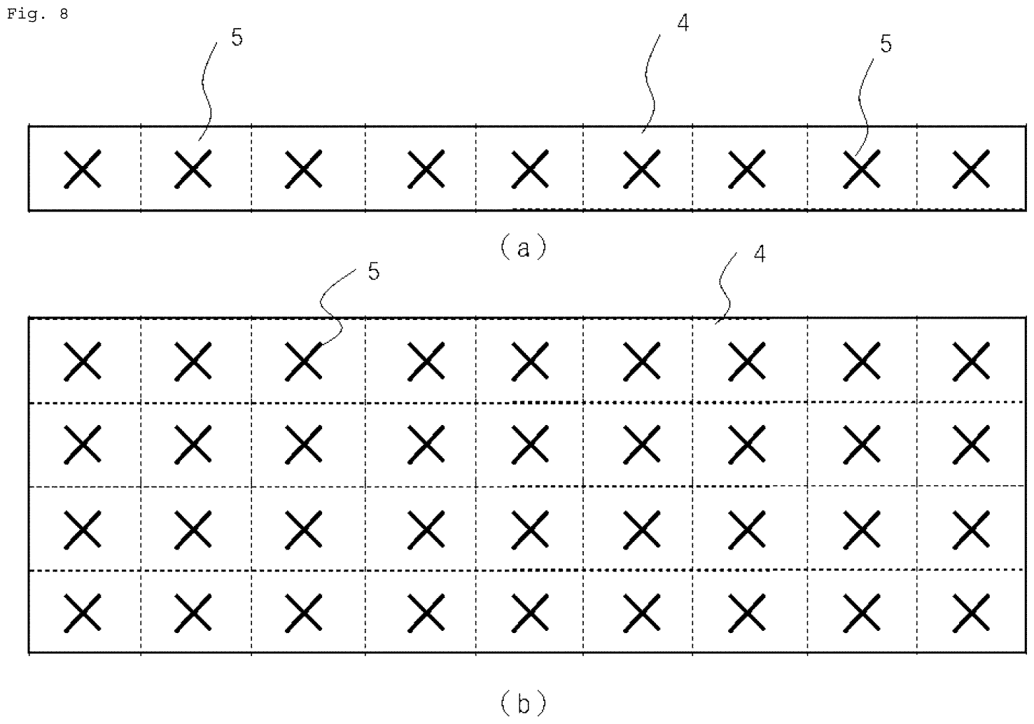

FIG. 9 shows views for describing a method for treating a decayed tooth; and

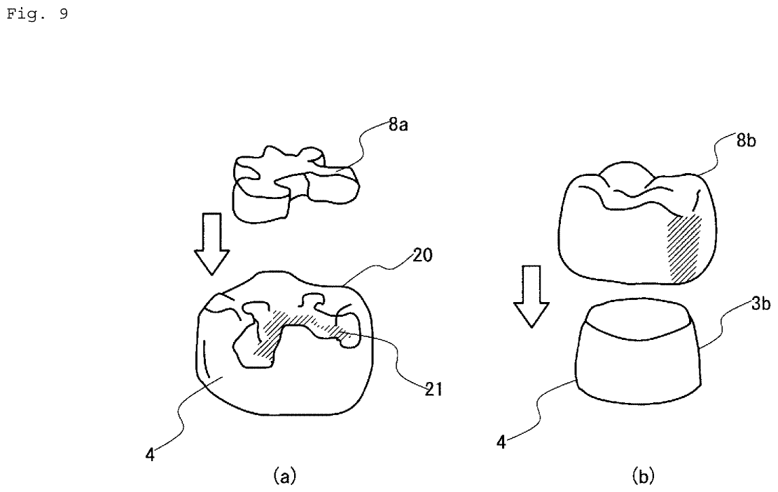

FIG. 10 is a schematic cross-sectional view of a tooth implanted in the implant treatment.

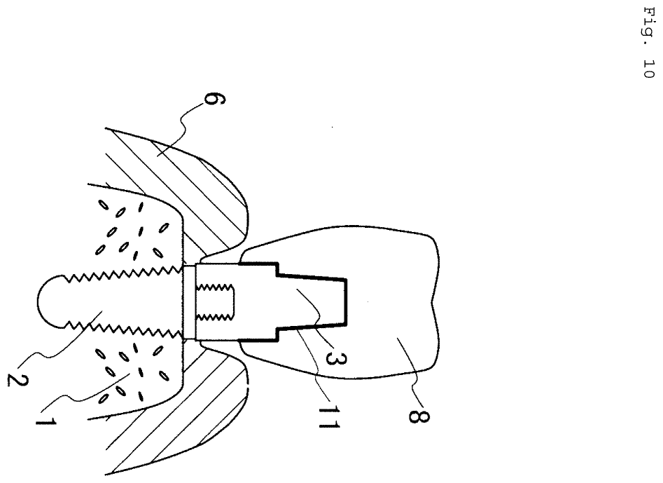

### EXPLANATIONS OF LETTERS OR NUMERALS

1 ALVEOLAR BONE

2 FIXTURE

3 ABUTMENT

3a ABUTMENT BASE PORTION

3c ABUTMENT TOOTH

4 INFLAMMATION PREVENTION SHEET

5 HOLE

5a BENT PORTION OF HOLE

6 GINGIVAL REGION

7 GINGIVAL CREVICE

8 TOOTH CROWN

9 EXCESS DENTAL CEMENT LAYER

10 ADJACENT TOOTH

11 DENTAL CEMENT LAYER

1. A method for using an inflammation prevention sheet that prevents inflammation caused by an excess of a dental cement used in a dental treatment, the method comprising:
inserting a treatment tooth through a hole provided in an elastic sheet made of rubber and/or plastic, and setting the sheet so as to cover an entirety of a periodontal region of the treatment tooth;
subsequently, filling the treatment tooth with a filling or covering the treatment tooth with a crown, and bonding together both with the dental cement; and
thereafter, removing the inflammation prevention sheet to which an excess dental cement, which has escaped from a root of the crown, has adhered.

2. A method for using an inflammation prevention sheet that prevents inflammation caused by an excess of a dental cement used in a dental implant treatment in which a fixture is implanted in a jawbone and is joined to an abutment, the abutment is covered with a tooth crown, and both are bonded together with the dental cement, the method comprising:
inserting the abutment through a hole provided in an elastic sheet made of rubber and/or plastic, and setting the sheet so as to cover a circumferential portion of a gingival crevice; and
removing the inflammation prevention sheet to which an excess dental cement, which has escaped from a seam between the tooth crown and the abutment after the abutment is covered with the tooth crown and both are bonded together with the dental cement, has adhered.

3. The method for using an inflammation prevention sheet according to claim 1,
wherein the inflammation prevention sheet to which the excess dental cement has adhered is removed before the cement is hardened.

4. The method for using an inflammation prevention sheet according to,
wherein the hole is a cut provided at a center of the inflammation prevention sheet.

5. An inflammation prevention sheet that prevents inflammation caused by an excess of a dental cement used in a treatment in which a treatment tooth with a decayed tooth part cut away is covered with a filling or a covering crown and the treatment tooth and the filling or the covering crown are bonded together with the dental cement,
wherein the inflammation prevention sheet is made of a thin elastic sheet made of rubber or plastic, which has a hole in a central portion, in which the treatment tooth is inserted through the hole, and which is set so as to cover an entirety of a periodontal region of the treatment tooth.

6. An inflammation prevention sheet that prevents inflammation caused by an excess of a dental cement used in a dental implant treatment in which a fixture is implanted in a jawbone and is joined to an abutment, the abutment is covered with a tooth crown, and both are bonded together with the dental cement,
wherein the inflammation prevention sheet is an elastic sheet made of rubber and/or plastic, which has a hole having a diameter slightly smaller than a diameter of the abutment, in which the abutment is inserted through the hole, and which is set so as to cover an entirety of a periodontal region of a tooth which is a target for the treatment.

7. The inflammation prevention sheet according to claim 5,
wherein a thickness of the sheet is 0.05 to 1.0 mm.

8. The inflammation prevention sheet according to claim 5,
wherein the sheet is made of a silicone resin or a fluorine resin which is water repellent.

9. The inflammation prevention sheet according to claim 5,
wherein a shape of the hole is any one of a circular shape, a star shape, a diamond shape, and an x shape.

10. The inflammation prevention sheet according to claim 5,
wherein the sheet is colored.
